(19) United States
(12) Patent Application Publication
(10) Pub. No.: US 2004/0196404 A1
(43) Pub. Date: Oct. 7, 2004

(54) Apparatus for wireless RF transmission of uncompressed HDTV signal

(75) Inventors: Kurt W. Loheit, Rolling Hills Estates, CA (US); William A. Salter, Torrance, CA (US)

Correspondence Address: SHIMOKAJI & ASSOCIATES, P.C., 1301 DOVE STREET SUITE 480, NEWPORT BEACH, CA, 92660, US

(73) Assignee: The Boeing Company, Seattle, WA (US)

(21) Appl. No.: 10/408,002

(22) Filed: Apr. 3, 2003

(51) Int. Cl. H04N 5/455; H04N 11/12

(52) U.S. Cl. 348/492; 348/726

(57) ABSTRACT

A system for transmitting and receiving an uncompressed HDTV signal over a wireless RF link includes a clock that provides a clock signal synchronized to the uncompressed HDTV signal and a data regeneration module connected to the clock, which provides a stream of regenerated data from the uncompressed HDTV signal. A demultiplexer demultiplexes the stream of regenerated data, using the clock signal, into an I data stream and a Q data stream. A modulator connected to the demultiplexer modulates a carrier with the I data stream and the Q data stream. A demodulator receives the carrier and demodulates the carrier so that the I data stream and the Q data stream are recovered. A multiplexer connected to the demodulator multiplexes the I data stream and the Q data stream into a single stream of HDTV data so that the uncompressed HDTV signal is recovered.

### BACKGROUND OF THE INVENTION

The present invention generally relates to wireless radio frequency (RF) transmission and reception of high definition television (HDTV) digital signals and, more particularly, to an apparatus for providing wireless RF transmission and reception of uncompressed HDTV signals—such as those generated from an HDTV camera, stored HDTV source or memory, or recorded images.

Common approaches for RF transmission of HDTV signals digitally compress the HDTV signal to address problems due to bandwidth and modulation limitations. For example, uncompressed transmission of HDTV signals occurs at a data rate of 1.485 giga-bits per second (Gbps), a data rate that is too high to be accommodated by conventional, low-bandwidth RF transmission. Digital compression reduces the data rate so that conventional, low-bandwidth RF transmission can be used. The resulting HDTV signal must be decompressed at the destination or receiving end of the RF link. The signal compression and decompression can generate artifacts that degrade the signal quality, and begin to negate the high picture quality specified by HDTV. In addition, latency generated by compression/decompression, i.e., the time delay between generation of the uncompressed HDTV signal and reception of the decompressed HDTV signal after compression and decompression, creates a time delay unacceptable for live broadcast synchronization.

It can be impractical, however, to use current, lower bandwidth, wireless RF systems to transmit uncompressed HDTV signals because complex and costly modulation and coding schemes are required to achieve reasonable HDTV performance. The Society of Motion Pictures and Television Engineers (SMPTE) standard 292M defines the electrical characteristics of the high definition HDTV signal. SMPTE standards also define the acceptable transmission medium for HDTV. For example, fiber optic cable, coaxial cable, and RF wireless transmission are all acceptable transmission media for HDTV signals.

HDTV signal transmission, for example, at an event or filming site, using any of the current cable, fiber optic, or wireless RF transmission capabilities, is subject to a variety of shortcomings. For example, if fiber optic cables are used they usually must be pre-installed at the event or filming site. Cables generally require permits to be obtained in advance and the time and cost for installation of cables can impose constraints on televising the event or filming. Fiber optic cables can be aesthetically undesirable, frequently unsafe, and often logistically impossible. For example fiber optic cables are usually buried months in advance for some golf events, and television engineers complain that a major headache in covering stadium sports events is the problem of fans tripping over their cables. Wireless RF transmission typically suffers from the digital compression problems, as described above, due to the limited bandwidth available using conventional, low-bandwidth RF transmission.

Television studios are now in the process of converting all of their broadcast productions exclusively to HDTV. In order for a high definition RF camera system to provide the same functionality as standard definition (SD), it is necessary to use an uncompressed digital link. Using an uncompressed link eliminates delays introduced by compression encoding and decoding. Such delays are unacceptable because they introduce production difficulties. Although wireless RF transmission of uncompressed HDTV signals has been achieved, for example, at a recent Super Bowl event, the RF transmission of uncompressed HDTV signals has been accomplished using on/off keying modulation. On/off keying is an inefficient form of modulation which imposes several limitations, for example, limited range, and which requires employing extremely high frequency radio waves in the 71-76 gigahertz (GHz) range, also known as V band (40-75 GHz) and W band (75-105 GHz), in order to accommodate the high, 1.485 Gbps, data rate.

RF transmission at such extremely high frequencies, however, also entails a number of technical difficulties. Technical difficulties for extremely high frequency RF transmission may include, for example, distortion due to the bandwidth required for high data rate, providing adequate transmit power, limitations on range, and antenna design tradeoffs. Link designs must trade between distance, effective radiated power (ERP), bit error rate (BER) performance, forward error correction, link margin, and component availability to develop a usable system. These technical difficulties become more critical in a portable wireless RF transmission system. Using modulators and receivers capable of performing at the 1.485 Gbps rate, an HDTV signal from a source—such as an HDTV camera or recorder—could be transmitted uncompressed to the proper facility for production—such as a local studio facility. Portable systems for transmission of uncompressed HDTV signals over wireless RF links could allow a portable hand-held camera to move from location to location within the receiver range, making HDTV transmission of sporting events or electronic newsgathering in real time possible. The ability to connect real-time to studios for instant direction and editing could offer the prospect of greatly reduced cost and cycle time for content creation.

As can be seen, there is a need for efficiently transmitting and receiving uncompressed HDTV signals over a wireless RF link. Also there is a need for high bandwidth, wireless RF links allowing the transmission of HDTV digital signals at the full 1.485 Gbps rate, that can be realized in a portable system that provides a quick, easy set-up where one HDTV signal can be transmitted and received over each link.

### SUMMARY OF THE INVENTION

In one aspect of the present invention, a system for transmitting and receiving an uncompressed HDTV signal over a wireless RF link includes: a clock that provides a clock signal synchronized to the uncompressed HDTV signal; and a data regeneration module connected to the clock, which provides a stream of regenerated data from the uncompressed HDTV signal, so that the clock signal is synchronized to the stream of regenerated data. The system also includes: a demultiplexer that demultiplexes the stream of regenerated data, using the clock signal, into an I data stream and a Q data stream; a modulator connected to the demultiplexer that modulates a carrier with the I data stream and the Q data stream; a demodulator that receives the carrier and demodulates the carrier so that the I data stream and the Q data stream are recovered; and a multiplexer connected to the demodulator and that multiplexes the I data stream and the Q data stream into a single stream of HDTV data that recovers the uncompressed HDTV signal.

In another aspect of the present invention, a system for transmitting an uncompressed HDTV signal over a wireless RF link includes a data regeneration module that provides a stream of regenerated data from the uncompressed HDTV signal. A clock provides a first clock signal synchronized to the stream of regenerated data. An encoder connected to the clock and to the data regeneration module encodes the stream of regenerated data, producing a stream of encoded data, and provides a second clock signal synchronized to the stream of encoded data. A demultiplexer connected to the encoder demultiplexes the stream of encoded data, using the second clock signal, into an I data stream and a Q data stream, and a modulator connected to the demultiplexer modulates a carrier with the I data stream and the Q data stream.

In yet another aspect of the present invention, a system for receiving an uncompressed HDTV signal over a wireless RF link includes a receiver front end that down converts an RF carrier to an IF frequency signal. A demodulator connected to the receiver front end and receives the IF frequency signal and demodulates the IF frequency signal so that an I data stream and a Q data stream are recovered. A multiplexer connected to the demodulator and that multiplexes the I data stream and the Q data stream into a single stream of HDTV data, and a decoder connected to the multiplexer decodes the single stream of HDTV data so that the uncompressed HDTV signal is recovered.

In still another aspect of the present invention, an HDTV system that transmits and receives an uncompressed HDTV signal over a wireless RF link includes a data regeneration module that provides a stream of regenerated data, having a data rate of 1.485 Gbps, from the uncompressed HDTV signal. A first clock provides a first clock signal synchronized to the stream of regenerated data, and the first clock uses edge detection of the stream of regenerated data to generate the first clock signal. An encoder connected to the clock and to the data regeneration module encodes the stream of regenerated data using a Reed-Solomon forward error correction code, producing a stream of encoded data, and also provides a second clock signal synchronized to the stream of encoded data, so that the stream of encoded data has a second data rate higher than the first data rate by a coding overhead of the Reed-Solomon forward error correction code; and the second clock signal has a rate higher than the first clock signal by the coding overhead. A demultiplexer connected to the encoder demultiplexes the stream of encoded data, using the second clock signal, into an I data stream and a Q data stream. A modulator connected to the demultiplexer modulates a carrier with the I data stream and the Q data stream. A receiver front end down converts an RF carrier to an IF frequency signal with an IF frequency greater than 1.5 GHz and less than 6 GHz. A demodulator connected to the receiver front end receives the IF frequency signal and demodulates the IF frequency signal so that an I data stream and a Q data stream are recovered. A second clock generates a second clock signal from the I data stream and the Q data stream; the second clock signal is synchronized to the I data stream and the Q data stream. A multiplexer connected to the demodulator and to the second clock uses the second clock signal to multiplex the I data stream and the Q data stream into a single stream of HDTV data, and a decoder connected to the multiplexer uses the second clock signal to decode the single stream of HDTV data so that the uncompressed HDTV signal is recovered.

In a further aspect of the present invention, a method for transmitting an uncompressed HDTV signal over a wireless RF link includes steps of: providing a stream of regenerated data from the uncompressed HDTV signal; providing a first clock signal synchronized to the stream of regenerated data; encoding the stream of regenerated data, producing a stream of encoded data; providing a second clock signal synchronized to the stream of encoded data; demultiplexing the stream of encoded data, using the second clock signal, into an I data stream and a Q data stream; modulating a carrier with the I data stream and the Q data stream; and transmitting the carrier over the wireless RF link.

In a still further aspect of the present invention, a method for receiving an uncompressed HDTV signal over a wireless RF link includes steps of: receiving the carrier over the wireless RF link; demodulating the carrier so that the I data stream and the Q data stream are recovered; multiplexing the I data stream and the Q data stream into a single stream of HDTV data; and decoding the single stream of HDTV data so that the uncompressed HDTV signal is recovered.

These and other features, aspects and advantages of the present invention will become better understood with reference to the following drawings, description and claims.

### BRIEF DESCRIPTION OF THE DRAWINGS

FIG. 1A is a system diagram showing an exemplary HDTV system using dual polarization (i.e. frequency re-use) to transmit two uncompressed HDTV signals over a single wireless RF channel, according to an embodiment of the present invention;

FIG. 1B is a system diagram showing an exemplary HDTV system with a wireless RF link transmitting uncompressed HDTV signals, according to an embodiment of the present invention;

FIG. 2A is a block diagram illustrating baseband electronics for transmission of uncompressed HDTV signals, according to an embodiment of the present invention;

FIG. 2B is a block diagram illustrating modulator and up converter electronics for transmission of uncompressed HDTV signals, according to an embodiment of the present invention;

FIG. 2C is a block diagram illustrating modulator and up converter electronics for transmission of uncompressed HDTV signals, according to another embodiment of the present invention;

FIG. 3A is a block diagram illustrating a single-polarization receiver front end for reception of uncompressed HDTV signals, according to one embodiment of the present invention;

FIG. 3B is a block diagram illustrating a dual circular polarization receiver front end for reception of two uncompressed HDTV signals over a single channel, according to another embodiment of the present invention;

FIG. 3C is a block diagram illustrating demodulator electronics for reception of uncompressed HDTV signals, according to an embodiment of the present invention;

FIG. 3D is a block diagram illustrating baseband electronics for reception of uncompressed HDTV signals, according to an embodiment of the present invention;

FIG. 4A is a flow chart illustrating a method for transmitting uncompressed HDTV signals, in accordance with an embodiment of the present invention; and

FIG. 4B is a flow chart illustrating a method for receiving uncompressed HDTV signals, in accordance with an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, one embodiment of the present invention provides for transmitting and receiving uncompressed high definition television (HDTV) signals over a wireless RF link at a variety of frequencies between about 18 giga-Hertz (GHz) and 44 GHz. The HDTV digital signals may be generated, for example, from an HDTV camera, stored HDTV source or memory, or recorded images. One embodiment provides high bandwidth, wireless RF links allowing the transmission of HDTV digital signals at the full 1.485 giga-bit per second (Gbps) rate, according to the Society of Motion Pictures and Television Engineers (SMPTE) standard 292M, for a portable system where one HDTV signal can be transmitted and received over each link. One embodiment may incorporate high-speed modulation to achieve line of sight RF links up to 10 kilometers in range. Such high speed modulation is described in U.S. patent application Ser. No. 10/071,954, filed Feb. 6, 2002, titled “High Speed QPSK MMIC and QAM Modulator”, having assignee in common with the present invention, and incorporated herein by reference. A method for providing a wireless RF communication link for transmitting uncompressed HDTV signals is described in U.S. patent application Ser. No. ______, filed concurrently with the present application, having assignee in common with the present invention, and incorporated herein by reference.

HDTV systems as specified by SMPTE standard 292M are clockless systems, i.e., the HDTV signal is not synchronized with a clock. In one embodiment, clock synchronization is provided to an HDTV signal so that efficient modulation schemes—such as QPSK and QAM—may be used to modulate the RF carrier with the HDTV data. Thus, the high data rate HDTV data at 1.485 Gbps may be efficiently modulated so that less bandwidth is required to transmit the signal over an RF link in accordance with an embodiment of the present invention. Therefore, in contrast to the prior art, RF links in accordance with an embodiment of the present invention may operate at a variety of frequency bands from 18 GHz up to 110 GHz. The RF links may be implemented as fixed or portable operation, and links may be one way (simplex) or full two-way (duplex). HDTV signals may be transmitted on the RF links from cameras or other HD sources to recorders, local studio facilities, or between studios for processing or distribution.

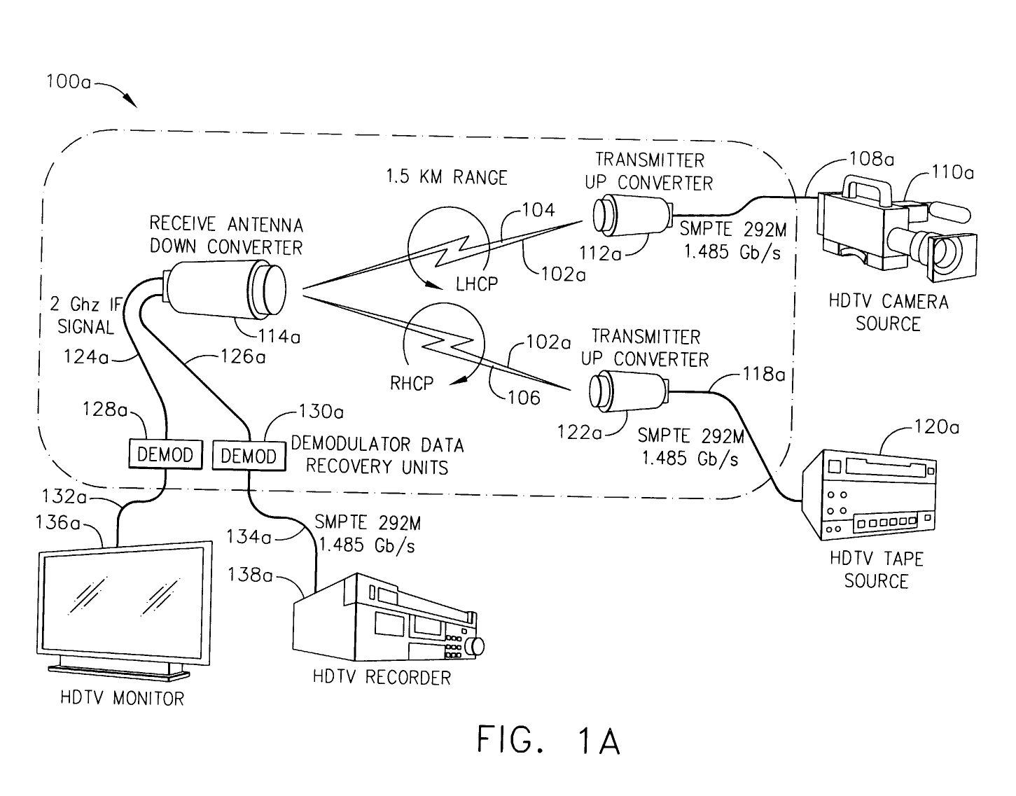

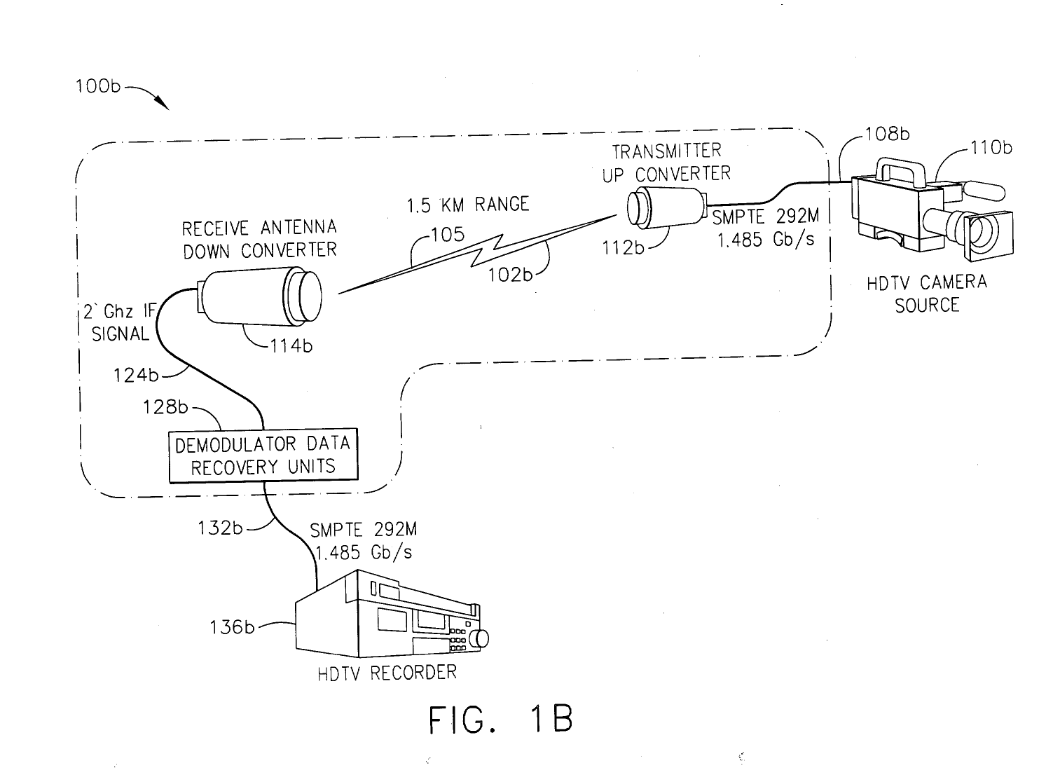

Referring now to FIGS. 1A and 1B, FIG. 1A illustrates an exemplary HDTV system 100a according to one embodiment and FIG. 1B illustrates an exemplary HDTV system 100b according to another embodiment. System 100a may include an RF channel 102a. A dual polarization technique may be used with RF channel 102a to provide signal transmission via left-hand circular polarization (LHCP) 104 and right-hand circular polarization (RHCP) 106 for frequency re-use over a single channel. System 100b may include an RF channel 102b. A single polarization or a conventional technique may be used with RF channel 102b, allowing one signal to be transmitted over the RF channel 102b.

System 100a may transmit an uncompressed HDTV signal 108a from source 110a, which may be, for example, an HDTV camera as shown in FIG. 1A. System 100a may transmit uncompressed HDTV signal 108a using transmitter 112a with the dual polarization technique to provide transmission via LHCP 104 over RF channel 102a to receiver 114a. Similarly, system 100a may transmit an uncompressed HDTV signal 118a from source 120a, which may be, for example, an HDTV tape source as shown in FIG. 1A. System 100a may transmit uncompressed HDTV signal 118a using transmitter 122a with the dual polarization technique to provide transmission via RHCP 106 over RF channel 102a to receiver 114a. HDTV signals 108a and 118a may conform to SMPTE standard 292M, and may have a data rate of 1.485 Gbps.

Receiver 114a may provide the received signal 124a corresponding to uncompressed HDTV signal 108a transmitted via LHCP 104, using dual polarization technique, over RF channel 102a to demodulator 128a. Similarly, receiver 114a may provide the received signal 126a corresponding to uncompressed HDTV signal 118a transmitted via RHCP 106, using dual polarization technique, over RF channel 102a to demodulator 130a. Demodulator 128a may provide an HDTV signal 132a to an HDTV device 136a, which may be, for example, an HDTV monitor as shown in FIG. 1A. Demodulator 130a may provide an HDTV signal 134a to an HDTV device 138a, which may be, for example, an HDTV recorder as shown in FIG. 1A. HDTV signals 132a and 134a may conform to SMPTE standard 292M, and may have a data rate of 1.485 Gbps. HDTV signals 132a and 134a may be recovered, respectively, from HDTV signals 108a and 118a.

Single channel system 100b is simpler but operates similarly to system 100a. Thus, system 100b may transmit an uncompressed HDTV signal 108b from source 110b, which may be, for example, an HDTV camera as shown in FIG. 1B. System 100b may transmit uncompressed HDTV signal 108b using transmitter 112b, using conventional or single polarization techniques, over the link 105 of RF channel 102b to receiver 114b. HDTV signal 108b may conform to Society of Motion Pictures and Television Engineers (SMPTE) standard 292M, and may have a data rate of 1.485 Gbps.

Receiver 114b may provide the received signal 124b corresponding to uncompressed HDTV signal 108b received over link 105 of RF channel 102b to demodulator 128b. Demodulator 128b may provide an HDTV signal 132b to an HDTV device 136b, which may be, for example, an HDTV recorder as shown in FIG. 1B. HDTV signal 132b may conform to Society of Motion Pictures and Television Engineers (SMPTE) standard 292M, and may have a data rate of 1.485 Gbps. HDTV signal 132b may be recovered from HDTV signal 108b.

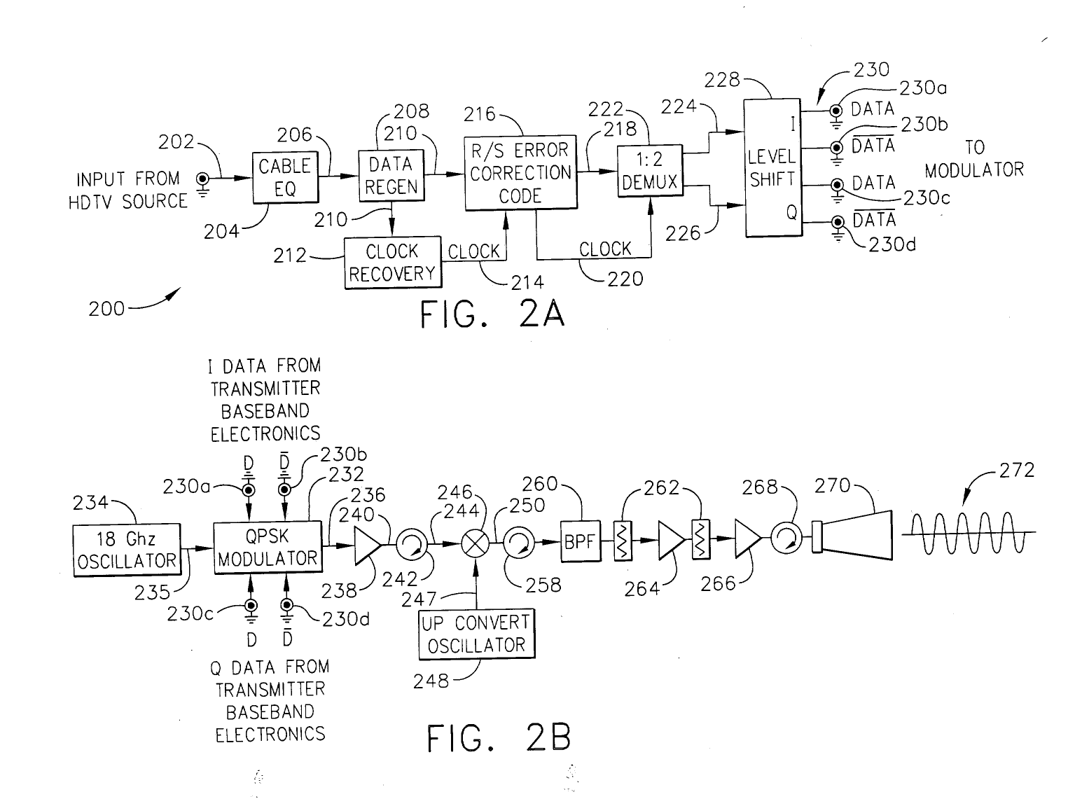

Referring now to FIG. 2A, system 200 illustrates baseband electronics for RF transmission of an uncompressed HDTV signal 202— such as signal 108a or 108b seen in FIGS. 1A and 1B—according to one embodiment. Uncompressed HDTV signal 202 may be equalized by equalizer 204 to compensate for any cable distortions due to cable length or type that, for example, may cause signal 202 to not meet SMPTE 292M requirements. For example, equalizer 204 may be a commercially available equalization device, as known in the art, so that equalized signal 206 meets the SMPTE 292M requirements. Data from equalized signal 206 may be regenerated at data regeneration module 208 to provide regenerated data 210 so that a clock signal 214 synchronized to regenerated data 210 may be provided by clock recovery module 212. For example, clock recovery at clock recovery module 212 may be provided by edge-detection of regenerated data 210. Also, for example, clock recovery at clock recovery module 212 may be provided by passing regenerated data 210 through a “times 2” multiplier to generate a clock signal 214 synchronized to regenerated data 210.

Regenerated data 210 and clock signal 214 may be used to perform forward error correction coding (FEC) at FEC module 216 to improve link performance. For example, Reed-Solomon coding, interleaving coding, or turbo product codes (TPC), as known in the art, may be used. Reed-Solomon coding has been chosen in the present example to illustrate one embodiment. Forward error correction coding performed by FEC module 216 requires adding redundancy to the signal (i.e. coding overhead) by intentionally adding bits to correct errors at the receiver without having to communicate back and forth with the transmitter for additional information on which bits are in error. Depending on the type of code used this can entail a coding overhead due to the additional capacity required by the forward error correction code, increasing the data rate. Thus, encoded data 218 may be provided at a higher data rate, for example, 1.607 Gbps, and clock signal 220 is provided at the higher rate to match the higher rate encoded data 218, so that the rate of clock signal 220 is higher than the rate of clock signal 214 by the coding overhead. For example, a phase-locked loop (PLL) may be included in FEC module 216 to generate the higher rate clock signal 220 and synchronize clock signal 220 to encoded data 218.

Clock signal 220 may be used as a timing source by demultiplexer 222 to demultiplex encoded data 218 into two data streams, an in-phase (I) data stream 224 and a quadrature (Q) data stream 226, as shown in FIG. 2A. The two synchronized data streams 224 and 226, which contain the data of the original uncompressed HDTV signal 202, may be used to provide efficient modulation of a carrier by the data of signal 202. For example, the amplitude and offset of the voltages representing the data streams 224 and 226 may be adjusted as illustrated by level shift module 228 and appropriate inputs 230 may be provided to modulator 232. For example, inputs 230 may include positive logic I data 230a, negative logic I data 230b, positive logic Q data 230c and negative logic Q data 230d.

Referring now to FIG. 2B, Modulator 232 may be, for example, a quadrature phase shift keying (QPSK) or quadrature amplitude modulation (QAM) implementation on a monolithic microwave integrated circuits (MMIC) chip, as described above. For example, a local oscillator (i.e., frequency source) 234 may provide the center frequency 235 at which modulator 232 operates, typically between 18 GHz and 23 GHz depending on frequency upconversion spur analysis, as known in the art. For example, local oscillator source 234 is illustrated as operating at 18 GHz in the embodiment illustrated in FIG. 2B. Modulator 232 output 236 may be a QPSK waveform that may be amplified by amplifier 238, which may be, for example, a commercially available gain stage. The amplified QPSK waveform 240 may be passed through an isolator 242, which may be, for example, a standard, commercially available component used to improve signal matching between stages, as known in the art. The QPSK waveform 244 may be fed to multiplier 246, which may upconvert waveform 244 with a signal at frequency 247 from local oscillator 248 to produce modulated signal 250 which is shown as:

s(t)cos2πfₒt

where s(t) is the incoming QPSK waveform 244 which may be shifted by sinusoid waveform cos2πfₒt. The Fourier transform of:

s(t)cos2πfₒt⇄1/2S(f−fₒ)+1/2S(f+fₒ)

which results in center frequencies equal to the sum and difference of the QPSK waveform 244 and frequency tone 247 of source local oscillator 248, as known in the art.

In an alternative embodiment, illustrated in FIG. 2C, a single local oscillator 252 may be used in place of local oscillator source 234 and the upconverting local oscillator 248. The signal 253 of local oscillator 252 may be split by splitter 254 and fed through attenuator 256 (signal 235) to modulator 232 and may also be fed (signal 247) to multiplier 246. Attenuator 256 may be used, for example, to provide a proper amplitude level of local oscillator 252 signal 235 to modulator 232. Thus, the center frequency of QPSK modulated signal 250 may be the sum of the frequencies 235 and 247, i.e., the sum of the frequency of local oscillator 252 added to itself. For example, for a local oscillator 252 operating at 18 GHz, the center frequency of modulated signal 250 is 36 GHz. Thus, for a local oscillator with frequencies in the range of 18-22 GHz, signal transmission over the wireless RF link may be provided with a signal having a center frequency in the range of 36-44 GHz.

Referring now to FIGS. 2B and 2C, modulated signal 250 may be fed through isolator 258, which, as above, may be, for example, a standard, commercially available component used to improve signal matching between stages, as known in the art. Modulated signal 250 may be passed through bandpass filter 260, for example, to select the desired center frequency and produce a “clean” signal, as known in the art. Bandpass filter 260 may require passing a minimum bandwidth of modulated signal 250 to achieve successful transmission of the HDTV data at the SMPTE standard 292M data rate of 1.485 Gbps. For example, the minimum required bandwidth necessary for a 1.485 Gbps QPSK waveform with error correction coding overhead producing a data rate of approximately 1.607 Gbps, as in the example given above, may be approximately 900 mega-Hertz (MHz).

Modulated signal 250 may then be passed through attenuators 262, pre-amplifier 264 and solid state power amplifier (SSPA) 266, and isolator 268 for transmission by transmit antenna 270, as shown in FIG. 2B. Or, modulated signal 250 may then be passed through attenuator 262, solid state high power amplifier (SSHPA) 267, and isolator 268 for transmission by transmit antenna 270, as shown in FIG. 2C. Thus, modulated signal 250 may be transmitted by a transmit antenna 270 as QPSK waveform modulated signal 272 carrying data of an uncompressed HDTV signal—such as uncompressed HDTV signal 202, 108a, 108b, or 118a-over a wireless RF link—such as link 102a or 102b, seen in FIGS. 1A and 1B.

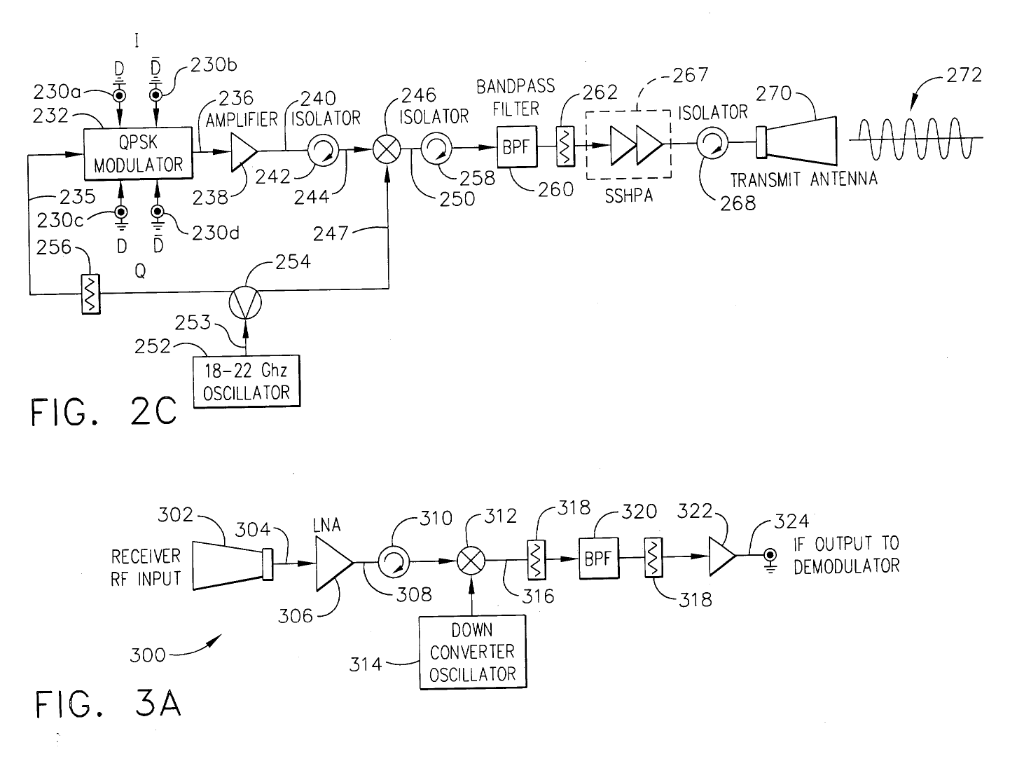

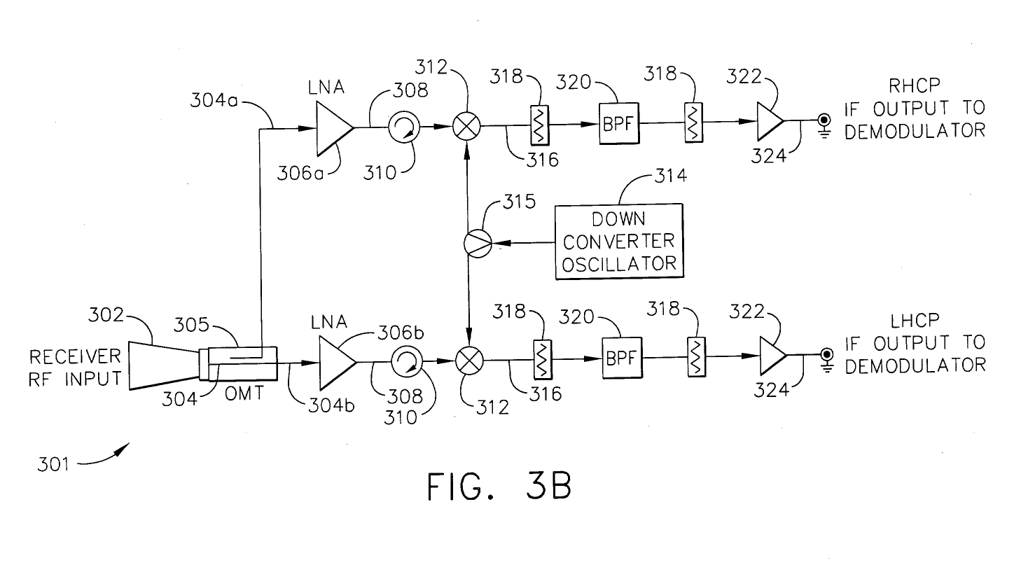

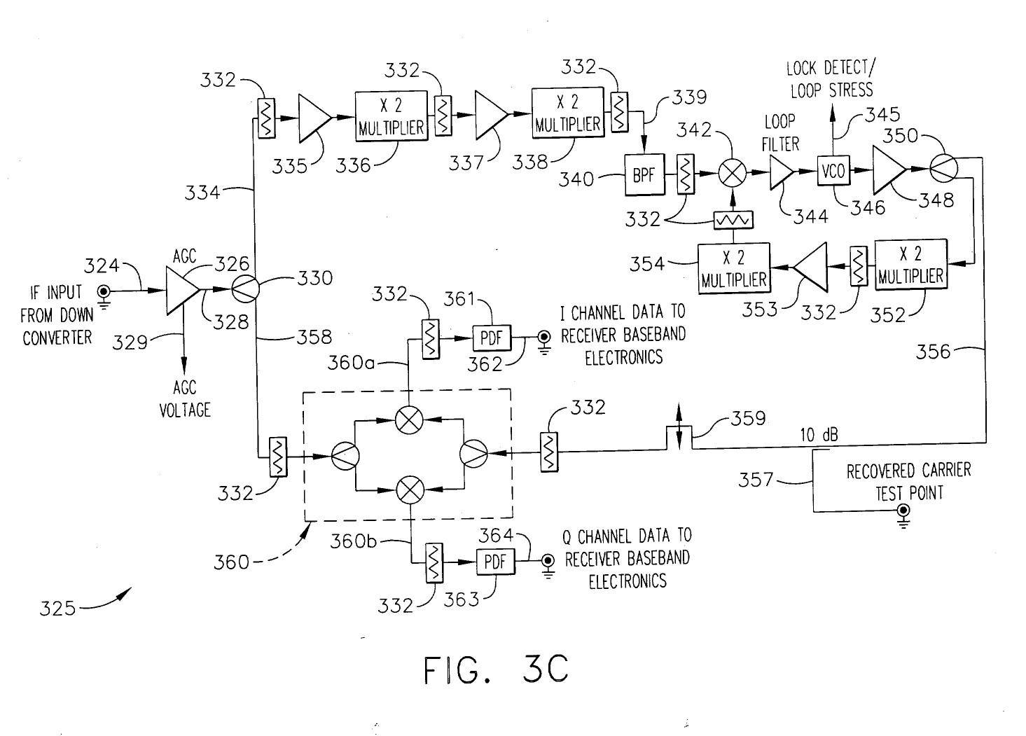

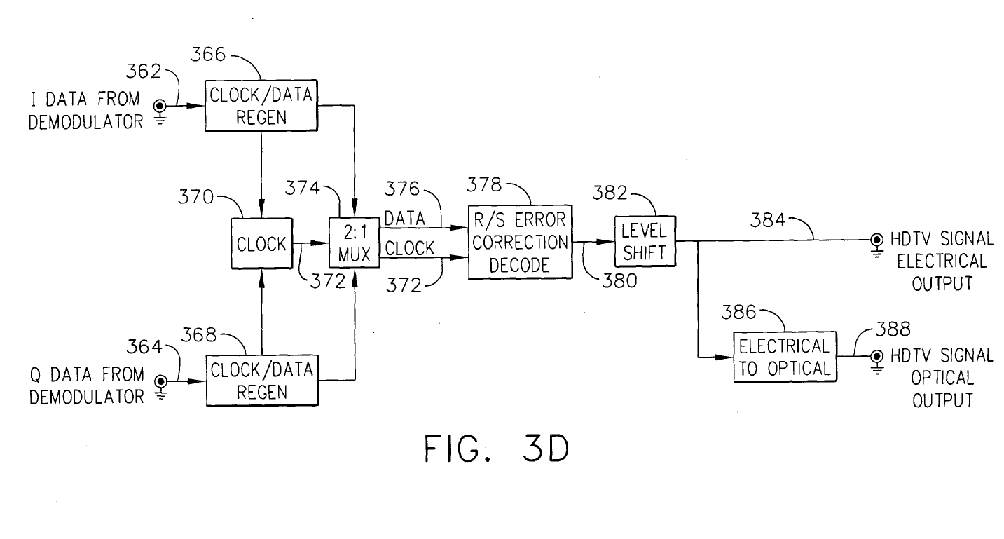

Referring now to FIGS. 3A and 3B, receiver front end 300 shown in FIG. 3A, illustrates RF reception, according to one embodiment, of an uncompressed HDTV signal—such as signal 108a or 108b seen in FIGS. 1A and 1B—that may be transmitted via a QPSK waveform modulated signal—such as modulated signal 272— that may be received by a receiving antenna 302. The received uncompressed HDTV signal 304 of modulated signal 272 may be passed to a low noise amplifier (LNA) 306.

In an alternative embodiment, illustrated by receiver front end 301 in FIG. 3B, received uncompressed HDTV signal 304 may comprise an LHCP signal 304a and an RHCP signal 304b-such as signals 108a and 118a sent over a single RF channel 102a using a dual polarization technique. The two signals, LHCP signal 304a and RHCP signal 304b, may be separated by an ortho-mode transducer 305, so that LHCP signal 304a may be passed to LNA 306a and RHCP signal 304b may be passed to LNA 306b. The alternative embodiment shown in FIG. 3B uses dual polarization to allow two transmitters to broadcast to a single receiver site. The two transmitters may operate on different polarizations, right-hand circular and left-hand circular, in order to take advantage of frequency reuse. The receive antenna utilizes an ortho-mode transducer 305 to separate the left and right polarization for low noise amplification, frequency down conversion, and data recovery. This method allows for transmitting two signals each from a different transmitter over the same frequency region. The single polarization down converter of the embodiment shown in FIG. 3A may simplify the electronics for single channel use.

Referring again to FIGS. 3A and 3B, the amplified signal 308 may be fed through isolator 310 to be down converted by multiplying amplified signal 308 at multiplier 312 by the output of local oscillator 314 to produce a down converted intermediate frequency (IF) signal 316 at a lower frequency than that of signal 304. (In the two-channel receiver alternative embodiment shown in FIG. 3B, output of local oscillator 314 may be fed through splitter 315 to provide the output of local oscillator 314 to a pair of multipliers 312 to provide an IF signal 316 for each channel.) For example, an IF between 1.5 GHz and 6 GHz may typically be chosen, so that a 2-GHz IF may be chosen to illustrate the present embodiment. IF signal 316 may passed through attenuators 318 and bandpass filter 320, and IF gain stage 322 to provide down converted IF carrier 324. Bandpass filter 320 may pass a bandwidth of 900 MHz, as described above, which may be a minimum required bandwidth necessary for a 1.485 Gbps QPSK waveform with error correction coding overhead producing a data rate of approximately 1.607 Gbps.

In a practical implementation, for example, the functions of receiver front end 300 or 301 including receiving antenna 302, LNA 306, and frequency down conversion including multiplier 312, local oscillator 314 and band pass filter 320 may be remotely located to provide optimum line-of-sight to a transmitter—such as transmitter 112a shown in FIG. 1A. Since the RF transmit frequency may not be fixed there can be numerous frequency output values for the local oscillator 314 in order to achieve the 2 GHz frequency for IF signal 316. A 2-GHz IF may be selected, for example, for simplification of routing. A 2-GHz IF may allow for significant distance between the receive antenna, which could be located on a crane or pole, and the baseband electronics, used to implement demodulation and decoding as further described below, located on the ground. A 2-GHz IF signal output can typically drive up to 100 feet of coaxial cable or be converted to an optical signal.

Referring now to FIG. 3C, IF carrier 324 may be passed to demodulator 325 for recovery of the baseband digital signals corresponding to I data stream 224 and Q data stream 226. Another example of a demodulator that also may be employed is described in U.S. patent application Ser. No. 10/123,574, filed Apr. 15, 2002, titled “QPSK and 16-QAM Self-generating Synchronous Direct Downconversion Demodulator”, having assignee in common with the present invention, and incorporated herein by reference. Demodulator 325 may take a coherent carrier recovered from IF carrier 324 and mix the coherent carrier with the modulated IF carrier 324 to generate a baseband I data stream 362 and Q data stream 364. Demodulator 325 is described in more detail as follows.

IF carrier 324 may be fed through automatic gain control (AGC) 326 which may have a minimum dynamic range of 20 decibels (dB) to provide a constant signal 328 to splitter 330. Signals at various points in the circuit may be passed through attenuators 332 to provide appropriate level matching, as described above. An AGC voltage 329 may be provided, for example, for monitoring of signal level on the front panel or by an operator in a control room. Signal 334 from splitter 330 may be passed through amplifier 335, “times 2” multiplier 336, amplifier 337, and “times 2” multiplier 338 to achieve multiplication, i.e., frequency shift, of the frequency of signal 334 by a factor of 4. Thus, following the example above, in which a 2-GHz IF has been chosen, the frequency of signal 334 may be 2 GHz and the frequency of signal 339 may be 8 GHz. Signal 339 may then be passed through a narrowband bandpass filter (BPF) 340, which may have a very high “Q” as understood by a person of ordinary skill in the art. The very high Q, which is measured by:

$$Q = \frac{resonant frequency}{bandwidth narrowband BPF}$$

of narrowband bandpass filter 340 may maximize the signal-to-noise ratio of signal 339 before it is passed to phase detector 342. Continuing with the examples above, the highest “Q” filter obtained without adding further hardware for temperature compensating effects is 160. For the exemplary frequency of signal 339 of 8 GHz, this would result in a narrowband filter bandwidth of 50 MHz.

Signal 339 may be passed to phase detector 342. Phase detector 342, loop filter 344, voltage controlled oscillator (VCO) 346, amplifiers 348 and 353, splitter 350, “times 2” multipliers 352 and 354 comprise a phase-locked loop, which may be used for recovery of a coherent carrier 356. For example, a coherent carrier 356 having a frequency of 2 GHz may be recovered that is locked in-phase to the carrier of constant signal 328. Coherent carrier 356 may be fed to quadrature detector 360. A lock detect voltage 345 may also be provided from VCO 346, for example, for monitoring of signal lock by an operator in a control room. A coupler 357, and a manual phase adjust control 359 may be provided, for example, for test point monitoring and trouble-shooting of the system. Manual phase adjust control 359 may be adjusted to achieve optimal phase alignment of coherent carrier 356 with signal 358, which may be provided from input constant signal 328 via splitter 330, in order to provide baseband I data stream 362 and baseband Q data stream 364 from quadrature detector 360 so that cross-talk between I data stream 362 and. Q data stream 364 may be minimized.

Signal 358 from splitter 330 also may be passed to quadrature detector 360. Quadrature detector 360 may be a conventional quadrature detector, as known in the art. In-phase output 360a of quadrature detector 360 may be passed through post detection filter (PDF) 361 to provide baseband I data stream 362. Likewise, quadrature output 360b of quadrature detector 360, which may differ concerning in-phase output 360a by approximately 90 degrees, may be passed through post detection filter 363 to provide baseband Q data stream 364. Post detection filters 361, 363 may be low pass filters, and the bandwidth of post detection filters 361, 363 may determine the overall bandwidth of the system. For example, post detection filters 361, 363 may be designed for an optimum BT-product of 0.56 which may optimize the signal-to-noise ratio of the data recovered in I data stream 362 and Q data stream 364. Thus, filter parameters for the filters in the system—such as bandpass filter 320, and post detection filters 361, 363— may be interdependent and based on the data rate, for example, 1.485 Gbps plus coding overhead. Continuing with the examples given above, the data rate with coding overhead may be approximately 1.607 Gbps, the band passed by the bandpass filter may have a bandwidth of approximately 900 MHz, and the cut-off frequency for the lowpass post detection filters may be approximately 450 MHz.

Referring now to FIG. 3D, bit synchronization and clock recovery may be performed on I data stream 362 and Q data stream 364, respectively, at clock/data regeneration modules 366 and 368 to provide a clock 370 that is synchronized with I data stream 362 and Q data stream 368. Clock 370 may provide clock signal 372, providing a timing source for the 2:1 multiplexing, by multiplexer 374, multiplexing I data stream 362 and Q data stream 364 to recover a single stream of encoded HDTV data 376 corresponding to encoded data 218 (shown in FIG. 2A). Single stream of HDTV data 376 may be provided at a rate of 1.485 Gbps plus coding overhead. For example, the data rate with coding overhead given in the example above for encoded data 218 was 1.607 Gbps and, following that example, the data rate of single stream of HDTV data 376 may also be 1.607 Gbps. The encoded HDTV signal, i.e., HDTV data 376, may be supplied a timing source from clock signal 372, for example, using error correction decode module 378— which may provide, for example, Reed-Solomon error correction code decoding for decoding single stream of encoded HDTV data 376, to generate, i.e., recover, the error corrected 1.485 Gbps HDTV signal 380.

The logic levels of error corrected HDTV signal 380 may be shifted, for example, by level shift module 382 after decoding to provide appropriate logic levels for adapting HDTV signal 380 to drive an electrical interface 384 or electrical to optical conversion may be performed at module 386 to drive an optical interface 388.

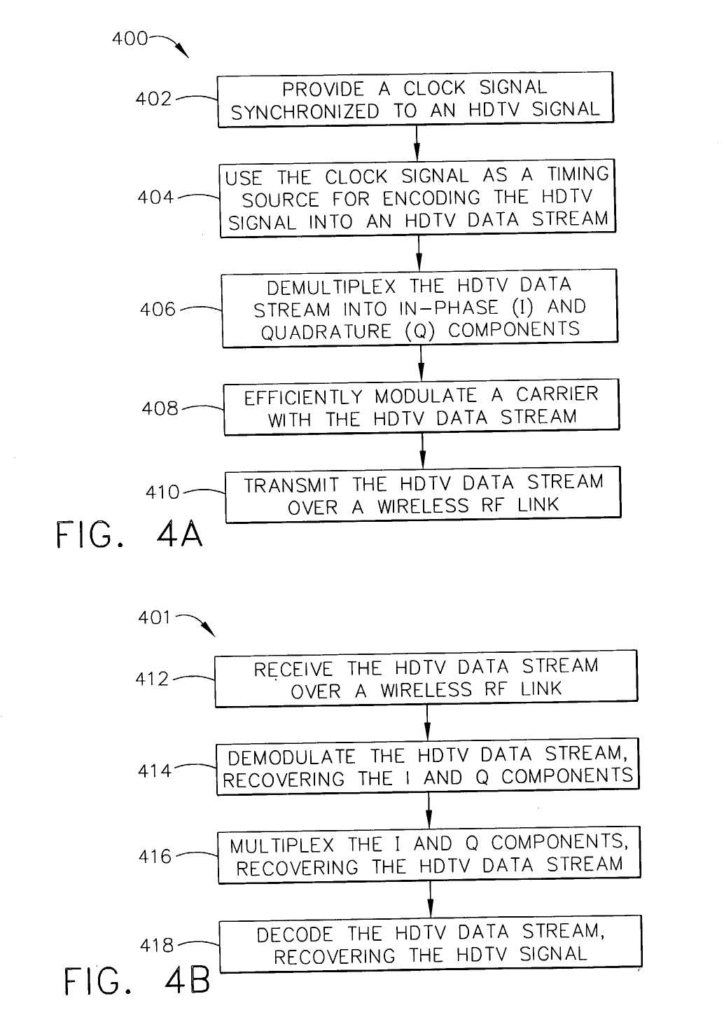

Referring now to FIGS. 4A and 4B, exemplary embodiments of a method 400 for transmitting and a method 401 for receiving an uncompressed HDTV signal—such as signal 108a or 108b seen in FIGS. 1A and 1B—are illustrated in flowchart form. Exemplary methods 400 and 401 may include steps 402, 404, 406, 408, 410, 412, 414, 416, and 418, which conceptually delineate methods 400 and 401 for purposes of conveniently illustrating methods 400 and 401 according to one embodiment. Exemplary methods 400 and 401 are illustrated with reference to FIGS. 2A, 2B, 2C, 3A, 3B, 3C and 3D.

Method 400 may begin with step 402, in which a clock signal may be synchronized to an HDTV signal. For example, data regeneration of equalized HDTV signal 206, or HDTV signal 108a or 108b, may be used with edge detection to provide synchronized clock signal 214.

Method 400 may continue with step 404, in which a synchronized clock signal may be used as a timing source for an encoder to encode the HDTV signal into an encoded data stream. For example, forward error correction coding—such as Reed-Solomon coding or turbo product coding—may be performed by the encoder, FEC module 216, in which synchronized clock signal 214 may be used as a timing source for FEC module 216 to provide a stream of encoded data 218 from HDTV signal 206. A higher rate clock signal 220 may be generated from the encoder, FEC module 216, using a PLL, in which higher clock rate signal 220 may be synchronized to the higher rate stream of encoded data 218.

Method 400 may continue with step 406, in which the encoded HDTV data stream may be demultiplexed into I and Q data streams. For example, higher rate synchronized clock signal 220 may enable demultiplexing, using a demultiplexer 222, of stream of encoded data 218 into I data stream 224 and Q data stream 226.

Method 400 may continue with step 408, in which an RF carrier may be efficiently modulated by the HDTV data stream. For example, a local oscillator source 234 may provide the center frequency 235 at which a modulator 232 operates and on which the HDTV data stream may be QPSK modulated by I data stream 224 and Q data stream 226 to provide modulator output 236, which may be upconverted to modulated signal 250. Other types of efficient modulation may also be used, for example, 16 QAM or higher order modulation.

Method 400 may continue with step 410, in which the HDTV data stream may be transmitted over a wireless RF link. For example, modulated signal 250 may be filtered, amplified, and transmitted by an antenna 270 as modulated signal 272 carrying data of an uncompressed HDTV signal—such as uncompressed HDTV signal 202, 108a, 108b, or 118a-over a wireless RF link—such as RF channel 102a or RF channel 102b, seen in FIGS. 1A and 1B, to a receiving antenna—such as receiving antenna 302.

Method 401 may continue from method 400 at step 412, in which the HDTV data stream may be received over a wireless RF link. For example, modulated signal 272 may be received at a receiving antenna 302 from a transmit antenna 270. The received uncompressed HDTV signal 304 of modulated signal 272 may be passed through a receiver front end—such as receiver front end 300 or receiver front end 301- to provide IF carrier 324 to a demodulator.

Method 401 may continue with step 414, in which an HDTV data stream may be demodulated from a carrier to recover I and Q data streams. For example, an IF carrier 324 may be demodulated by a demodulator 325 to recover an I data stream 362 and a Q data stream 364.

Method 401 may continue with step 416, in which I and Q data streams may be multiplexed into a single encoded HDTV data stream. For example, I data stream 362 and Q data stream 364 may be multiplexed into a single stream of encoded HDTV data 376, which effectively recovers the transmitted encoded data 218. I data stream 362 and Q data stream 364 may be multiplexed with the aid of a clock signal 372 generated by clock data recovery using edge detection, for example, from I data stream 362 and Q data stream 364.

Method 401 may continue with step 418, in which an HDTV data stream may be decoded into an error corrected HDTV signal—such as HDTV signal 380, meeting the SMPTE 292M standard—that effectively recovers the original HDTV signal—such as signal 108a or 108b. For example, single stream of HDTV data 376 may be decoded by Reed-Solomon error correction decode module 378, to generate, i.e., recover, the error corrected 1.485 Gbps HDTV signal 380.

It should be understood, of course, that the foregoing relates to preferred embodiments of the invention and that modifications may be made without departing from the spirit and scope of the invention as set forth in the following claims.

We claim:

1. A system for transmitting and receiving an uncompressed HDTV signal over a wireless RF link, comprising:
a clock that provides a clock signal synchronized to the uncompressed HDTV signal;
a data regeneration module connected to said clock and that provides a stream of regenerated data from the uncompressed HDTV signal, wherein said clock signal is synchronized to said stream of regenerated data;
a demultiplexer that demultiplexes said stream of regenerated data, using said clock signal, into an I data stream and a Q data stream;
a modulator connected to said demultiplexer that modulates a carrier with said I data stream and said Q data stream;
a demodulator that receives said carrier and demodulates said carrier so that said I data stream and said Q data stream are recovered;
a multiplexer connected to said demodulator and that multiplexes said I data stream and said Q data stream into a single stream of HDTV data that recovers the uncompressed HDTV signal.

2. The system of claim 1, further comprising:
an encoder connected to said data regeneration module and that encodes said stream of regenerated data, producing a stream of encoded data;
and provides a second clock signal synchronized to said stream of encoded data; and wherein:
said demultiplexer demultiplexes said stream of encoded data, using said second clock signal, into said I data stream and said Q data stream.

3. The system of claim 1, wherein said clock uses edge detection of said uncompressed HDTV signal to generate said clock signal.

4. The system of claim 1, wherein said clock uses a “times-2” multiplier with said uncompressed HDTV signal to generate said clock signal.

5. The system of claim 2, wherein said encoder includes a PLL that generates said second clock signal.

6. The system of claim 2, wherein said encoder performs forward error correction coding of said stream of regenerated data.

7. The system of claim 1, wherein said modulator is a QPSK MMIC modulator.

8. The system of claim 1, further comprising:
a local oscillator connected to said modulator;
a multiplier connected to said modulator and to said local oscillator so that said carrier is upconverted to a modulated signal having twice the frequency of said local oscillator.

9. The system of claim 1, further comprising:
a receiver front end that down converts a modulated signal to said carrier at an IF frequency.

10. The system of claim 1, further comprising:
a decoder connected to said multiplexer that decodes said single stream of HDTV data to recover the uncompressed HDTV signal.

11. A system for transmitting an uncompressed HDTV signal over a wireless RF link, comprising:
a data regeneration module that provides a stream of regenerated data from the uncompressed HDTV signal;
a clock that provides a first clock signal synchronized to said stream of regenerated data;
an encoder connected to said clock and to said data regeneration module and that encodes said stream of regenerated data, producing a stream of encoded data, and that provides a second clock signal synchronized to said stream of encoded data;
a demultiplexer connected to said encoder that demultiplexes said stream of encoded data, using said second clock signal, into an I data stream and a Q data stream; and
a modulator connected to said demultiplexer that modulates a carrier with said I data stream and said Q data stream.

12. The system of claim 11, wherein:
said encoder encodes said stream of regenerated data using a forward error correction code;
said stream of regenerated data has a first data rate of 1.485 Gbps; and
said stream of encoded data has a second data rate higher than said first data rate by a coding overhead of said forward error correction code;
and said second clock signal has a rate higher than said first clock signal by said coding overhead.

13. The system of claim 11, wherein said clock uses edge detection of said stream of regenerated data to generate said first clock signal.

14. The system of claim 11, wherein said clock uses a “times-2” multiplier with said stream of regenerated data to generate said first clock signal.

15. The system of claim 11, wherein said encoder includes a PLL that synchronizes said second clock signal to said stream of encoded data.

16. The system of claim 11, wherein said encoder performs Reed-Solomon forward error correction coding of said stream of regenerated data.

17. The system of claim 11, wherein said modulator is a 16-QAM MMIC modulator.

18. The system of claim 11, further comprising:
a local oscillator connected to said modulator, said local oscillator providing a frequency in the range of 18-22 GHz;
a multiplier connected to said modulator and to said local oscillator so that said carrier has a center frequency twice the frequency of said local oscillator.

19. A system for receiving an uncompressed HDTV signal over a wireless RF link, comprising:
a receiver front end that down converts an RF signal to an IF frequency carrier;
a demodulator connected to said receiver front end and that receives said IF frequency carrier and demodulates said IF frequency carrier so that an I data stream and a Q data stream are recovered;
a multiplexer connected to said demodulator and that multiplexes said I data stream and said Q data stream into a single stream of encoded HDTV data; and
a decoder connected to said multiplexer that decodes said single stream of encoded HDTV data so that the uncompressed HDTV signal is recovered.

20. The system of claim 19, further comprising:
a clock that generates a clock signal from said I data stream and said Q data stream, said clock signal synchronized to said I data stream and said Q data stream; and wherein:
said multiplexer is connected to said clock and uses said clock signal as a timing source to multiplex said I data stream and said Q data stream into said single stream of encoded HDTV data.

21. The system of claim 20, wherein said clock signal provides a timing source for decoding said single stream of encoded HDTV data.

22. The system of claim 19, wherein said receiver front end down converts said RF signal to a carrier having an IF frequency greater than 1.5 GHz and less than 6 GHz.

23. The system of claim 19, further comprising:
an ortho-mode transducer that separates an LHCP signal from an RHCP signal.

24. An HDTV system that transmits and receives an uncompressed HDTV signal over a wireless RF link, said HDTV system comprising:
a data regeneration module that provides a stream of regenerated data, having a first data rate of 1.485 Gbps, from the uncompressed HDTV signal;
a first clock that provides a first clock signal synchronized to said stream of regenerated data wherein said first clock uses edge detection of said stream of regenerated data to generate said first clock signal;
an encoder connected to said clock and to said data regeneration module and that encodes said stream of regenerated data using a Reed-Solomon forward error correction code, producing a stream of encoded data, and that includes a PLL that provides a second clock signal synchronized to said stream of encoded data, wherein said stream of encoded data has a second data rate higher than said first data rate by a coding overhead of said Reed-Solomon forward error correction code; and said second clock signal has a rate higher than said first clock signal by said coding overhead;
a demultiplexer connected to said encoder that demultiplexes said stream of encoded data, using said second clock signal, into an I data stream and a Q data stream;
a modulator connected to said demultiplexer that modulates a carrier by said I data stream and said Q data stream.
a receiver front end that down converts an RF signal to an IF frequency carrier with an IF frequency greater than 1.5 GHz and less than 6 GHz;
a demodulator connected to said receiver front end and that receives said IF frequency carrier and demodulates said IF frequency carrier so that an I data stream and a Q data stream are recovered;
a second clock that generates a third clock signal from said I data stream and said Q data stream, said third clock signal synchronized to said I data stream and said Q data stream;
a multiplexer connected to said demodulator and to said second clock and that uses said third clock signal to multiplex said I data stream and said Q data stream into a single stream of encoded HDTV data; and
a decoder connected to said multiplexer and that uses said third clock signal to decode said single stream of encoded HDTV data so that the uncompressed HDTV signal is recovered.

25. The HDTV system of claim 19, further comprising:
an ortho-mode transducer that separates an LHCP signal carrying a first uncompressed HDTV signal from an RHCP signal carrying a second uncompressed HDTV signal.

26 A method for transmitting an uncompressed HDTV signal over a wireless RF link, comprising steps of:
providing a stream of regenerated data from the uncompressed HDTV signal;
providing a first clock signal synchronized to said stream of regenerated data;
encoding said stream of regenerated data, producing a stream of encoded data;
providing a second clock signal synchronized to said stream of encoded data;
demultiplexing said stream of encoded data, using said second clock signal, into an I data stream and a Q data stream;
modulating a carrier with said I data stream and said Q data stream; and
transmitting said carrier in a signal over the wireless RF link.

27. The method of claim 26, wherein:
said step of encoding said stream of regenerated data comprises using a forward error correction code;
said stream of regenerated data has a first data rate of 1.485 Gbps;
said stream of encoded data has a second data rate higher than said first data rate by a coding overhead of said forward error correction code;
and said second clock signal has a rate higher than said first clock signal by said coding overhead.

28. The method of claim 26, wherein said step of providing said first clock signal synchronized to said stream of regenerated data comprises using edge detection of said stream of regenerated data to generate said first clock signal.

29. The method of claim 26, wherein said step of providing said first clock signal synchronized to said stream of regenerated data comprises using a “times-2” multiplier with said stream of regenerated data to generate said first clock signal.

30. The method of claim 26, wherein said step of providing said second clock signal comprises using a PLL that synchronizes said second clock signal to said stream of encoded data.

31. The method of claim 26, wherein said step of encoding said stream of regenerated data comprises Reed-Solomon forward error correction coding.

32. The method of claim 26, wherein said step of modulating said carrier comprises QPSK modulation of an IF carrier by said I data stream and said Q data stream and frequency upconversion of said IF carrier to said carrier.

33. The method of claim 26, wherein said step of transmitting said carrier in said signal comprises transmitting said signal with a circular polarization.

34. A method for receiving an uncompressed HDTV signal over a wireless RF link, comprising steps of:
receiving a carrier in a signal over the wireless RF link;
demodulating said carrier so that said I data stream and said Q data stream are recovered;
multiplexing said I data stream and said Q data stream into a single stream of encoded HDTV data; and
decoding said single stream of encoded HDTV data so that the uncompressed HDTV signal is recovered.

35. The method of claim 34, further comprising a step of:
generating a clock signal from said I data stream and said Q data stream, said clock signal synchronized to said I data stream and said Q data stream; and wherein said multiplexing step comprises:
using said clock signal to multiplex said I data stream and said Q data stream into a single stream of encoded HDTV data.

36. The method of claim 34, wherein said clock signal provides a timing source for decoding said single stream of encoded HDTV data.

37. The method of claim 34, further comprising a step of down converting said signal to a carrier having an IF frequency greater than 1.5 GHz and less than 6 GHz.

38. The method of claim 34, further comprising steps of:
separating an LHCP signal from an RHCP signal;
recovering a first uncompressed HDTV signal from said LHCP signal; and
recovering a second uncompressed HDTV signal from said RHCP signal.
